(19) United States
(12) Patent Application Publication
(10) Pub. No.: US 2009/0234695 A1
(43) Pub. Date: Sep. 17, 2009

(54) SYSTEM AND METHOD FOR HARVESTING SCHEDULING, PLANTING SCHEDULING AND CAPACITY EXPANSION

(76) Inventors: Mangesh D. Kapadi, Bangalore (IN); Jinendra K. Gugaliva, Bangalore (IN); Lingathurai Palanisamy, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 11/872,826

(22) Filed: Oct. 16, 2007

(51) Int. Cl. G06Q 10/00; G06N 5/02; G06Q 50/00

(52) U.S. Cl. 705/8; 706/52; 705/10

(57) ABSTRACT

A harvesting and/or planting schedule is generated based on a product recovery model and a crop yield model. The product recovery model models recovery of a product, such as sugar, from a crop, such as sugarcane. The crop yield model models yield of the crop from land. First, second, third, and fourth data are used to generate the harvesting and/or planting schedule. The first input data is pertinent to predicting the recovery of the product by use of the product recovery model. The second input data is pertinent to predicting the yield of the crop by use of the crop yield model. The third input data relates to capacity of a crop processing plant to process the crop to produce the product. The fourth input data relates to harvesting and/or planting practices for the crop. The first, second, third, and fourth input data are processed so as to determine an optimum harvesting and/or planting schedule for the crop as a function of the product recovery model, the crop yield model, the crop processing capacity, and the harvesting and/or planting practices.

### TECHNICAL FIELD

A method and/or apparatus is disclosed herein for predicting an optimum time for harvesting, an optimum time for planting, and/or an optimum range for capacity.

### BACKGROUND

Sugarcane is a member of the grass family and is valued chiefly for the juices (specially sucrose) that can be extracted from its stems. The raw sugar that is produced from these juices is later refined into white granular sugar.

Sugarcane, which is the raw material for the production of sugar, is a perennial crop. One planting of sugarcane generally results in three to six annual harvests before replanting is necessary. The very first harvest after the planting is called “Plant Cane,” while the subsequent harvests before the next replanting are called “Stubble” or “Ratoon.” The first stubble or ratoon is the first harvest following the plant cane harvest, the second stubble or ratoon is the second harvest following the plant cane harvest, and so on.

A typical sugar processor buys sugarcane from various farmers, and these farmers usually have contracts with the sugar processors. Each sugar processor knows the planting date of each crop of the different farmers and the varieties of the sugarcane. The long-term viability of the sugar industry depends upon finding ways to produce sugar more economically through production management decisions that reduce production costs or increase return. In general, cost effectiveness of this industry can be enhanced by optimally utilizing resources. Sugarcane, the chief raw material for this industry, has an important impact on profitability.

An important management decision in sugarcane production is when to harvest the individual fields of sugarcane over the long harvesting period, up to 12 months in some countries. As is known, harvest scheduling, which includes decisions about when to harvest which variety (or cultivar) at what age of the sugarcane, is one practice that has a direct impact on yield (amount of sugarcane per acre of land) and recovery (amount of sugar per ton of sugarcane) and hence sugar production. If sugarcane fields are harvested at the optimal time when yield and recovery are high, the net sugar produced will increase.

However, high capital costs associated with milling, harvesting, transport, and storage dictate that cane harvesting and milling occur over a prolonged period of time. In other words, all fields of sugarcane will not be necessarily harvested at the time of maximum cane yield and/or recovery. Moreover, there exists a tradeoff between recovery and yield with respect to harvest age among certain cane varieties because the age at which sugarcane yield is maximum is not necessarily the optimum age for sugar recovery.

In addition, sugarcane yield and sugar recovery within a sugar mill region vary with a combination of deterministic parameters (e.g., variety, crop class or ratoon type, age, harvest date indicating season) and stochastic parameters (e.g., weather conditions, soil type, farming practices, irrigation facilities). Therefore, the opportunities to maximize productivity at the farm level and profitability at the industry level by better scheduling the harvesting date given the length of the current harvest season and the capacity for harvesting and milling are important issues to consider.

Several studies have attempted to develop models for estimating the percentage of sucrose in sugarcane at the farm level. Whan, et al., in “Scheduling Sugar Cane Plant and Ratoon Crops and a Fallow—a Constrained Markov Model,” Journal of Agriculture Engineering Research, vol. 21, pages 281-289, 1976, suggested developing sugar yield in response to harvest date and age using regression equations calculated from field trial data.

A method is disclosed herein for the development and application of optimization models to maximize productivity at the individual farm level and profitability at the mill or industry level. A methodology for scheduling the harvest, scheduling the planting, and determining appropriate capacity expansion at an industry level is developed. Such a modeling approach can be used to maximize sugar yield and net revenue in relation to harvest date, crop age, crop variety, crop ratoon number, and/or the like. Mathematical optimization techniques, such as linear or integer programming, can be applied to make optimum decisions on when to plant and/or when to harvest given the yield and recovery attributes, as well as restrictions associated with milling capacity and/or planting practice.

### BRIEF DESCRIPTION OF THE DRAWINGS

Features, aspects, and advantages of the present invention will become better understood when the following detailed description is read with reference to the accompanying drawings in which:

FIG. 1 shows example data illustrating variations in the planting a sugarcane varieties by zone;

FIG. 2 is a flow chart representing an example of a program that can be executed for optimizing planting and harvesting scheduling taking into account sugarcane processing capacity;

FIG. 3 illustrates overall yearly distribution of a harvest load (amount of sugarcane) as a function of age as indicated by the training set of example data;

FIG. 4 illustrates an example of main and special harvest seasons start and end dates and main and special harvest seasons start ranges; and,

FIG. 5 illustrates a computer as an example mechanism for executing the program of FIG. 2.

### DETAILED DESCRIPTION

### Analysis of Current Planting Practices

To understand the benefits of planting and/or harvest scheduling, it is important to know current planting practices. One can accumulate training data related to planting, such as planted variety, crop class or ratoon type, and/or planting area. The planting area can be divided into different zones, depending on soil type, soil quality, weather conditions, and irrigation facilities available. The planting variation across zones for varieties (example data is shown in the following table) may be analyzed.

| | Indian | Indian | Indian | Indian |
|---|---|---|---|---|
| Zone | Variety 01 | Variety 02 | Variety 01 | Variety 02 |
| Code | Plant Cane | Plant Cane | Ratoon | Ratoon |
| 01 | 14.57 | 10.45 | 14.33 | 10.25 |
| 02 | 6.64 | 15.17 | 6.95 | 13.38 |
| 03 | 25.27 | 7.83 | 24.76 | 8.53 |
| 04 | 8.94 | 8.01 | 8.92 | 7.94 |
| 05 | 11.13 | 20.06 | 12.58 | 19.17 |
| 06 | 19.59 | 4.16 | 17.29 | 4.16 |
| 07 | 2.26 | 14.84 | 2.72 | 15.12 |
| 08 | 11.60 | 19.49 | 12.45 | 21.45 |

It is clear from the above table that Indian Variety 01 is mainly planted in zone 03, followed by zone 06, while zones 08 and 05 prefer planting variety Indian Variety 02. The percentage distributions for plant cane and ratoon for a variety are almost the same as the ratoon fields are the harvested plant cane fields. The percentage values mentioned in the above table indicate the total planting for a variety in a given zone in the entire plantation year.

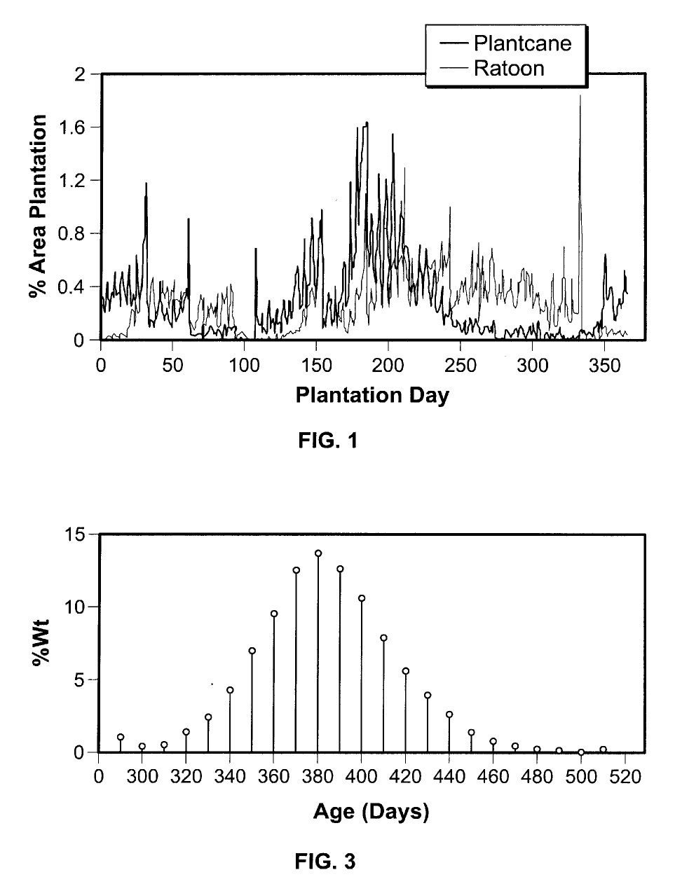

However, within the planting year, there is variation depending upon such factors as water availability. FIG. 1 represents such variation for variety Indian Variety 01. In FIG. 1, planting day 1 represents August 1 while planting day 365 (366 for leap year) is July 31.

The harvest season for an industry is for a limited number of days, such as a season that begins on November 1 (planting day 93) and finishes at around the end of June (planting day 334). During the entire harvest season, a constant load equal to the crushing capacity of a factory or mill, such as 5000 ton/day, needs to be crushed. Hence, looking at planting variation across the year and knowing the harvesting and crushing constraints, it is clear that not all sugarcane fields will be harvested at an optimal time with respect to sugar recovery and/or sugarcane yield.

Hence, one objective of a total planting and harvest scheduling solution is to get the sugarcane load into the factory in such a way that productivity at the farm level and profitability at the industry level are maximized. It should be noted that, at any point, the area harvested for a given age cannot be greater than the area available to harvest at that age (based on plantation). Hence another objective of a total planting and harvest scheduling solution is to plant a sugarcane load in such a way that optimal values for sugar recovery and/or sugarcane yield, for planted sugarcane loads, are realized during decided harvesting season.

### Overall Approach to Increase Net Farm Returns

The optimal harvest and planting scheduling of sugarcane fields is an important consideration for increasing the returns in the sugar mill area. Harvest scheduling needs to ensure that sugarcane loads are crushed at the optimal time when the yield and recovery are at their peaks so that the net sugar produced is maximized. For this purpose, sugarcane yield and recovery, which are dependent upon a combination of deterministic parameters (variety, ratoon type, age, season of harvest, etc.) and stochastic parameters (weather conditions, soil type, farming practices, etc.) have to be accurately estimated.

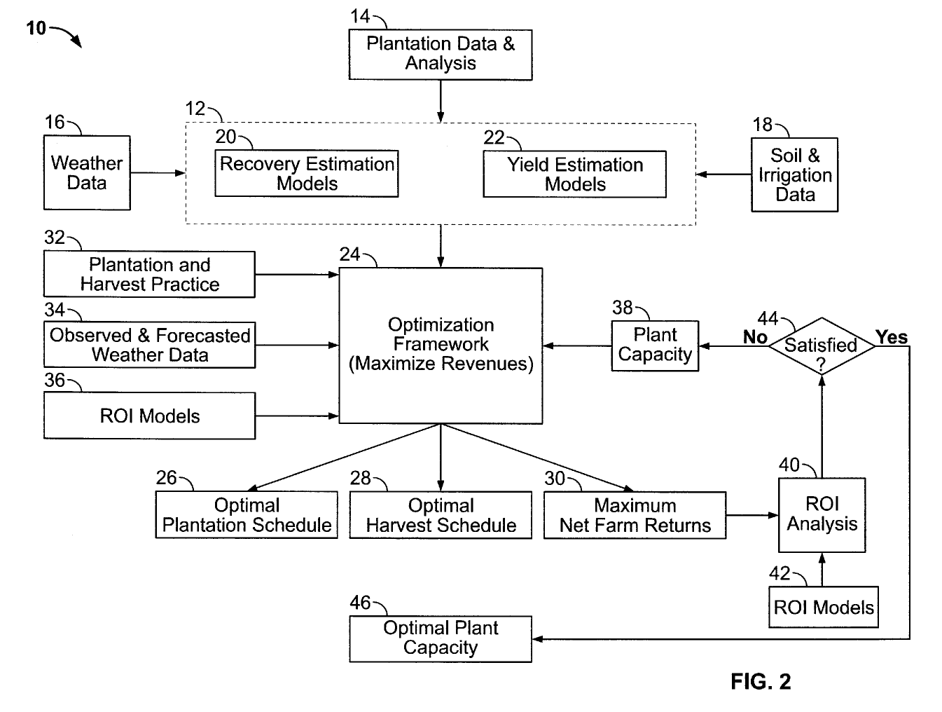

As shown in FIG. 2, an overall modeling procedure 10 maximizing overall industry return begins with a sugarcane yield and sugar recovery estimating procedure 12 that develops a model for estimating sugar recovery and sugarcane yield at the individual farm level. As will be understood below, the input to the sugarcane yield and sugar recovery estimating procedure 12 is training data that includes yield and recovery data 14 as a function of season and age, yield and recovery data 16 as a function of weather conditions, and yield and recovery data 18 as a function of soil conditions and irrigation facilities.

In addition, mill crushing capacity may not be sufficient to crush all sugarcane loads at the optimal yield and recovery time. Hence, it may be profitable to expand the capacity of an existing sugar mill, considering the enhanced sugar production revenues post capacity rise. However, these decisions on plant capacity cannot be made based on recovery-yield considerations alone. These decisions have also to be supported with a return on investment (ROI) analysis. Moreover, profitability forecasts for various ‘what-if’ scenarios have to be considered in order to make decisions robust and reliable. The overall approach presented below addresses these needs in an effective manner.

### Mathematical Formulation for Harvest Scheduling

To arrive at optimal harvest schedules, sugar recovery and sugarcane yield have to be accurately estimated, taking into consideration the effects of plant variety, crop ratoon number, harvest age, harvest season, weather, soil conditions, and/or the like.

### Recovery Prediction

The sugarcane yield and sugar recovery estimating procedure 12 includes a sugar recovery modeling procedure 20. A methodology for the sugar recovery modeling procedure 20 has been developed in co-pending U.S. patent application Ser. No. 11/445,053 filed on Jun. 1, 2006 for the estimation of sugar recovery \hat{r}_{d,v,a} (e.g., percentage of sucrose in the sugarcane). The entire disclosure of U.S. patent application Ser. No. 11/445,053 filed on Jun. 1, 2006 is incorporated herein by reference.

As disclosed in the '053 application, day-wise sugar recovery \hat{r}_{d,v}^{JD} dependent upon the effect of Julian Date is expressed by the following second order polynomial equation:

\hat{r}_{d,v}^{JD}=(aᵥ)(JD_{d}²)+(bᵥ)(JD_{d})∀d,∀v (1)

where d represents harvesting day, v represents plant variety, JD_{d} is a variable representing Julian Date for harvesting day d, aᵥ represents a parameter for variety v so as to model the Julian Date effect on sugar recovery, and bᵥ represents another parameter for variety v so as to model the Julian Date effect on sugar recovery. The harvesting date d is the actual date rather than Julian Date. Julian Dates are the numerical values representing the harvesting season, where August 1 has a numerical value of 1 and where July 31 has a numerical value of 365 (or 366 in a Leap Year). It should be noted that selection of August 1 as Julian Date 1 is chosen to be dependent on selected regional weather conditions and can vary by country and/or by weather conditions. Accordingly, equation (1) is the seasonal dependent sugar recovery model.

The day-wise sugar recovery \hat{r}_{d,v,a}^{A} of sugar dependent upon the effect of the age of the crop at the time of harvesting is expressed by the following second order equation:

\hat{r}_{d,v,a}^{A}=(cᵥ)(Ā_{d,v,a}²)+(dᵥ)(Ā_{d,v,a}) (2)

where a represents age, Ā_{d,v,a} is a variable representing the weighted average age of the load belonging to age group a for variety v on harvesting day dᵥ and cᵥ and dᵥ are parameters for variety v so as to model the age effect on sugar recovery. As in the case of equation (1), the harvesting date d is the actual date rather than Julian Date. Accordingly, equation (2) is the sugar recovery age model.

The models given by equations (1) and (2) can be combined to address both seasonal and age dependent effects on sugar recovery as given by the following equation:

\hat{r}_{d,v,a}^{(JD,A)}=\hat{r}_{d,v,a}^{A}−eᵥ∀d,∀v,∀a (3)

or

\hat{r}_{d,v,a}^{(JD,A)}=(aᵥ)(JD_{d}²)+(bᵥ)(JD_{d})+(cᵥ)(Ā_{d,v,a}²)+(dᵥ)(Ā_{d,v,a})−eᵥ∀d,∀v,∀a (4)

A bias term eᵥ has been added for each variety v, and equation (4) results for substituting equations (1) and (2) into equation (3). Equation (4) can be used to determine a predicted sugar recovery for a harvesting day d, for a sugarcane variety v, and for an age group a. The predicted recovery value for a harvesting day d for all varieties and age groups can be obtained using weight fractions and is given by the following equation:

$${\hat{r}}_{d} = {\sum }_{v = 1}^{{N}_{v}} {\sum }_{a = 1}^{{N}_{a}} ( {W}_{d , v , a} ) ( {\hat{r}}_{d , v , a} ) ∀ d \qquad ( 5 )$$

where Nᵥ is the set of sugarcane varieties, Nₐ is the set of age groups, and W_{d,v,a} is a weight fraction for a load of age group a and variety v on harvesting day d

The combined model represented by equations (4) and (5) can be fitted to the production and harvest training data of an industry in order to estimate the parameters aᵥ, bᵥ, cᵥ, dᵥ, and eᵥ. The estimation of these parameters is solved as an optimization problem according to the following objective function:

$${min}_{{a}_{v} , {b}_{v} , {c}_{v} , {d}_{v} , {e}_{v}} {\sum }_{d = 1}^{{N}_{d}} {ɛ}_{d}^{ab s} \qquad ( 6 )$$

where N_{d} is the set of harvesting days, and ε_{d}^{abs} represents the absolute error between the predicted sugar recovery rd for all varieties and ages predicted by equations (4) and (5) using the training data and the actual sugar recovery \hat{r}_{d} given by the training data for all varieties and ages. The training data includes all sugar recovery data and harvest data by season, by age, and by variety collected from one or more past harvests.

Those skilled in the art will recognize that various constraints may be placed upon the solution of equation (6) to ensure expeditious as well as optimal solutions. Such constraints, for example, may include one or more of the following:

ε_{d}^{abs}≧R_{d}−\hat{r}_{d}∀d (7)

ε_{d}^{abs}≧−(R_{d}−\hat{r}_{d})∀d (8)

ε_{d}^{abs}≦R_{d}∀d (9)

R_{d}−2.0≦\hat{r}_{d,v,a}≦R_{d}+0.75∀d,∀v,∀(a=1, . . . , 5,16, . . . , 23) (10)

R_{d}−0.75≦\hat{r}_{d,v,a}≦R_{d}+2.0∀d,∀v,∀(a=6, . . . , 15) (11)

The quantity ε_{d}^{abs} always stores the positive difference between R_{d} and \hat{r}_{d}. The numbers 0.75 and 2.0 are illustrative only and may change depending on geography and the training data selected for creating the models described herein.

As discussed in the aforementioned '053 application, there will still be a residual error that is obtained after modeling the seasonal and age dependent effects on sugar recovery. This residual error is due at least in part to un-modeled weather effects and can be predicted using weather information as given by the following equation:

\hat{f}_{d}^{W}=\hat{f}_{d}^{RF}+\hat{f}_{d}^{MT}+\hat{f}_{d}^{ΔT}∀d (12)

where \hat{f}_{d}^{RF} is the residual rain fall model that considers the effect of rainfall on sugar recovery, \hat{f}_{d}^{MT} is the residual maximum temperature model that considers the effect of the maximum temperature on sugar recovery, and \hat{f}_{d}^{ΔT} is the residual delta temperature model that considers the effect of the difference between the maximum and minimum temperature on sugar recovery.

The model \hat{f}_{d}^{RF}, for example, may include three terms as given by the following equation:

\hat{f}_{d}^{RF}=\hat{f}_{d}^{RF}^{₁}+\hat{f}_{d}^{RF}^{₁₀}+\hat{f}_{d}^{RF}^{₃₀}∀d (13)

The first term \hat{f}_{d}^{RF}^{₁} captures the rainfall effect for the last ten days as given in the following equation:

$${\hat{f}}_{d}^{{RF}_{1}} = ( {\sum }_{i = 1}^{10} {rf}_{i} ) ( {\sum }_{z = 1}^{{N}_{z}} ( {WZ}_{d , z} ) ( {RF}_{d - i , z} ) ) ∀ d \qquad ( 14 )$$

where i represents a rainfall summation index, rfᵢ is a parameter that models the rainfall effect on sugar recovery, z is a summation index representing zone or area of the field, N_{z} is the set of all zones, WZ_{d,z} represents a weight fraction for a sugarcane load from zone z on harvesting day d, and RF_{d,z} is a variable representing the rainfall in zone z on harvesting day d. A time period other than ten days can instead be used in connection with equation (14).

The second term \hat{f}_{d}^{RF}^{₁₀} in Equation (13) captures the effect of rainfall in the period of the last eleven to sixty days as given by the following equation:

$${\hat{f}}_{d}^{{RF}_{10}} = ( {\sum }_{i = 1}^{5} {rf}_{i + 10} ) ( {\sum }_{z = 1}^{{N}_{z}} ( {WZ}_{d , z} ) ( {\sum }_{m = 1}^{30} {RF}_{d - 10 i - m , z} ) ) ∀ d \qquad ( 15 )$$

where m is a summation index. A time period other than eleven to sixty days and slots other than ten day slots can instead be used in connection with equation (15).

The rainfall effect for the remaining six months is captured in monthly slots (slots of 30 days) as given by the following equation:

$${\hat{f}}_{d}^{{RF}_{30}} = ( {\sum }_{i = 1}^{6} {rf}_{i + 15} ) ( {\sum }_{z = 1}^{{N}_{z}} ( {WZ}_{d , z} ) ( {\sum }_{m = 1}^{30} {RF}_{d - 30 i - m - 30 , z} ) ) ∀ d \qquad ( 16 )$$

A number of months other than six and slots other than thirty day slots can instead be used in connection with equation (16).

The model \hat{f}^{MT}, for example, may contain two terms as given by the following equation:

\hat{f}_{d}^{MT}=\hat{f}_{d}^{MT}^{₁₀}+\hat{f}_{d}^{MT}^{₃₀}∀d (17)

The first term \hat{f}_{d}^{MT}^{₁₀} considers the maximum temperature effect for the last two months in ten day slots, while the second term \hat{f}_{d}^{MT}^{₃₀} considers the maximum temperature effect for the remaining four months (out of the last six months) in thirty day slots. Hence, these two terms are given by the following equations:

$$\begin{matrix}{\hat{f}}_{d}^{{MT}_{10}} = ( {\sum }_{j = 1}^{6} {mt}_{j} ) ( {\sum }_{z = 1}^{{N}_{z}} ( {WZ}_{d , z} ) ( {\sum }_{m = 1}^{10} {MT}_{d - 10 j - m + 10 , z} ) ) ∀ d & ( 18 ) \\ {\hat{f}}_{d}^{{MT}_{30}} = ( {\sum }_{j = 1}^{4} {mt}_{j + 6} ) ( {\sum }_{z = 1}^{{N}_{z}} ( {WZ}_{d , z} ) ( {\sum }_{m = 1}^{30} {MT}_{d - 30 j - m - 30 , z} ) ) ∀ d & ( 19 )\end{matrix}$$

where j represents a maximum temperature summation index, mtⱼ is a maximum temperature parameter useful in modeling the maximum temperature effect on sugar recovery, and MT_{d,z} is a variable for the maximum temperature in zone z on harvesting day d. A time period other than the last two months and slots other than ten day slots can instead be used in connection with equation (18), and a time period other than the remaining four months (out of the last six months) and slots other than thirty day slots can instead be used in connection with equation (19).

The model \hat{f}_{d}^{ΔT} is very similar to the maximum temperature model and is given by the following equation:

\hat{f}_{d}^{ΔT}=\hat{f}_{d}^{ΔT}^{₁₀}+\hat{f}_{d}^{ΔT}^{₃₀}∀d (20)

The first term \hat{f}_{d}^{ΔT}^{₁₀} considers the delta temperature effect for the last two months in ten day slots, while the second term \hat{f}_{d}^{ΔT}^{₃₀} considers the delta temperature effect for the remaining four months (out of the last six months) in thirty day slots. Hence, these two terms are given by the following equations:

$$\begin{matrix}{\hat{f}}_{d}^{Δ {T}_{10}} = ( {\sum }_{k = 1}^{6} δ {t}_{k} ) ( {\sum }_{z = 1}^{{N}_{z}} ( {WZ}_{d , z} ) ( {\sum }_{m = 1}^{10} Δ {T}_{d - 10 k - m + 10 , z} ) ) ∀ d & ( 21 ) \\ {\hat{f}}_{d}^{Δ {T}_{30}} = ( {\sum }_{k = 1}^{4} δ {t}_{k + 6} ) ( {\sum }_{z = 1}^{{N}_{z}} ( {WZ}_{d , z} ) ( {\sum }_{m = 1}^{30} Δ {T}_{d - 30 k - m - 30 , z} ) ) ∀ d & ( 22 )\end{matrix}$$

where k represents a delta temperature summation index, where δtₖ is a delta temperature parameter useful in modeling the delta temperature effect on sugar recovery, and ΔT_{d,z} is the delta temperature variable for zone z on harvesting day d. A time period other than the last two months and slots other than ten day slots can instead be used in connection with equation (21), and a time period other than the remaining four months (out of the last six months) and slots other than thirty day slots can instead be used in connection with equation (22).

The combined model \hat{f}_{d}^{W} that predicts the effect of weather conditions on sugar recovery comprises, for example, a total forty-one parameters (twenty-one for rainfall and ten each for maximum temperature and delta temperature). These parameters may be determined by plugging the training data into the appropriate equations and computing values for the corresponding parameters. In other words, these equations are made to fit this training data. It should be noted that other weather effects such as relative humidity, wind direction and speed, etc. can also be included in dynamic weather model. Also, the total number of 41 parameters used for the weather model are based on the structure of the current representative model and other numbers of parameters can be used.

The last step in the modeling of sugar recovery prediction is to combine \hat{r}_{d,v,a}^{(JD,A)} and \hat{f}_{d}^{W}. This combination is initiated by the following equation:

$${\hat{r}}_{d} = {\sum }_{v = 1}^{{N}_{v}} {\sum }_{a = 1}^{{N}_{a}} ( {W}_{d , v , a} ) ( {\hat{r}}_{d , v , a} ) + {\hat{f}}_{d} ∀ d \qquad ( 23 )$$

and by modifying the optimization objective function given by Equation (6) as given by the following equation:

$${min}_{{a}_{v} , {b}_{v} , {c}_{v} , {d}_{v} , {e}_{v} , {rf}_{i} , {mt}_{j} , δ {t}_{k}} {\sum }_{d = 1}^{{N}_{d}} {ɛ}_{d}^{abs} \qquad ( 24 )$$

As before in connection with equation (6), those skilled in the art will recognize that various constraints may be placed upon the solution of equation (24) to ensure expeditious as well as optimal solutions.

Accordingly, the prediction model for recovery of sugar from sugarcane is given generally by the following equation:

\hat{r}_{v,d,a}=\hat{r}_{v,d,a}^{(JD,A)}+\hat{f}_{d}^{W} (25)

where \hat{r}_{v,d,a}^{(JD,A)} is given by equation (4), and \hat{f}_{d}^{W} is given by equations (12)-(22), and the combined model is optimized by equations (23) and (24). The combined model so developed is used to predict the sugar recovery for the planted sugarcane fields. The combined model explained here is an example way for recovery prediction for those skilled in area. However, any reliable mathematical framework and/or heuristic procedures and/or evolutionary techniques and/or experts' or researchers' understanding, etc. can be used to correctly estimate sugar recovery using the above mentioned parameters.

### Yield Prediction

The sugarcane yield and sugar recovery estimating procedure 12 of FIG. 2 includes a sugarcane yield modeling procedure 22. A methodology for the sugarcane yield modeling procedure 22 to model the prediction of sugarcane yield ŷ_{d,v,a} is given below. Yield is modeled based on the effects of season, age, weather conditions, and/or soil conditions.

### Modeling Season (Julian Date) Effect on Yield

Each effect on sugarcane yield is modeled independently of the other effects. As a first step, the seasonal effect on sugarcane yield is captured. The seasonal effect is represented in the form of julian date (julian date is equivalent to planting date as mentioned earlier), although other representations could be used. It in order to analyze variations in sugarcane yield due to the seasonal effect, the age of the sugarcane should be fixed, such as to the 390-400 day range, in order to minimize the age effect on sugarcane yield variations. As can be seen from FIG. 3, the particular age group of 390-400 days is a dominant age group in the example harvest training data and, therefore, can provide a reasonable data size for analysis. The average sugarcane yields for all varieties are considered in this analysis.

The same exercise is repeated by considering variety specific data. Generally, it has been found that the trend in the overall sugarcane yield variation with respect to harvest month so as to capture the seasonal effect is substantially the same as the trend in sugarcane yield variations of at least the dominant varieties with respect to harvest month. However, variety wise, the sugarcane yield versus harvest data curves can move up (for a rich sugarcane yield variety) or down (for a poor sugarcane yield variety).

The relationship between the average sugarcane yield and harvest month (expressed in terms of julian date) is generally polynomial in nature. The following equation captures the polynomial relationship between sugarcane yield and julian date:

ŷ_{v,d}^{JD}=α_{v,p}^{y}(JD_{d})^{p}+α_{v,p-1}^{y}(JD_{d})^{p-1}+ . . . +α_{v,1}^{y}(JJD_{d})¹+α_{v,0}^{y} (26)

for all v and d, where p represents the order of the polynomial, ŷ_{v,d}^{JD} is a variable representing the predicted sugarcane yield for variety v on day d because of only the julian date effect, and α_{v,p}^{y} is a parameter for variety v to model the julian date effect for a polynomial of order p on sugarcane yield.

### Modeling Age Effect on Yield

The relationship between the average sugarcane yield and age of the sugarcane is generally quadratic in nature. Typically, sugarcane yield increases with the age of the sugarcane as maturity adds mass to the sugarcane. However, this trend reverses after a certain age, as evaporation dries out the sugarcane mass. This domain understanding also suggests the quadratic relationship between sugarcane yield and its age at harvest.

Further, to confirm this understanding, the variation of average sugarcane yield (considering all the varieties) as function of age of the sugarcane can be studied with the training data. The training data is actual recovery and yield data accumulated with respect to past harvests over a period of time and is used as described herein to determine the parameters of the prediction models.

It is important that this variation in average sugarcane yield as a function of age should only be due to the age effect so that the underlying conclusion related to this relationship is unbiased. Therefore, the analysis of the effect of age on sugarcane yield should be carried out for those sugarcane entries which are harvested in the same season (e.g., same month of a given year). In other words, in order to analyze variations in sugarcane yield due to the age effect, the season of the sugarcane should be fixed so as to minimize the season effect on sugarcane yield variations. This constraint helps to minimize the seasonal and weather effects on this variation. For this analysis, sugarcane load entries harvested in a particular month, such as, for example, March of a particular year, may be considered. Depending on geography, the month of March is the top harvest month in each year and, therefore, can provide reasonable sized data for the analysis.

The quadratic relationship between sugarcane yield and the age effect is given in the following equation:

ŷ_{v,a}^{A}=cᵥ^{y}a²+dᵥⁱa+eᵥ^{y} (27)

for all v and a, where cᵥ^{y}, dᵥ^{y}, and eᵥ^{y} are parameters for variety v to model the age effect on sugarcane yield, and ŷ_{v,a}^{A} represents the predicted yield for age a of variety v because of the age effect only. The quadratic nature of age effect on yield of the crop is illustrative only and can be non-linear or a polynomial of higher order.

### Combined Modeling of Julian Date and Age

The individual seasonal and age effect models given above are useful for considering the impact analysis of the individual effects. However, to make these models more suited in an optimization framework, they can be combined in order to address both the seasonal and age effects simultaneously. The combined model is given by the following equation:

ŷ_{v,d,a}^{(JD,A)}=ŷ_{v,d}^{JD}+ŷ_{v,a}^{A}+δᵥ^{y} (28)

for all v, d, and a, where ŷ_{v,d,a}^{(JD,A)} is the predicted yield for age a of variety v on day d combining julian date and age effects, ŷ_{v,d}^{JD} is given be equation (26), ŷ_{v,a}^{A} is given be equation (27), and δᵥ^{y} is a bias term for variety v to model the julian and age effects on yield. The bias term δᵥ^{y} is determined during optimization.

Using equations (26) and (27), equation (28) can be expanded as given by the following equation:

ŷ_{v,d,a}^{(JD,A)}=α_{v,p}^{y}(JD_{d})^{p}+α_{v,p-1}^{y}(JD_{d})^{p-1}+ . . . +α_{v,1}^{y}(JD_{d})¹+cᵥ^{y}a²+dᵥ^{y}a+γᵥ^{y} (29)

for all v, d, and a, where

a=d−pd+1 (30)

and γᵥ^{y} is an aggregation of all constant terms as given by the following equation:

γᵥ^{y}=α_{v,0}^{y}+eᵥ^{y}+δᵥ^{y} (31)

for all v.

The model represented by equations (24) and (31) may be fitted to production and harvest training data during the training (modeling) phase in order to estimate optimal values for the parameters α_{v,p}^{y} to α_{v,1}^{y}, cᵥ^{y}, dᵥ^{y}, and γᵥ^{y}. The estimation problem is solved as an optimization problem. The optimization problems is stated as an objective function by the following equation:

$${min}_{( {α}_{v , p}^{y} , {α}_{v , p - 1}^{y} , … , {α}_{v , 1}^{y} , {c}_{v}^{y} , {d}_{v}^{y} , {γ}_{v}^{y} )} {\sum }_{n = 1}^{{N}_{E}} {ɛ}_{n}^{abs} \qquad ( 32 )$$

where N_{E} represents the total number of harvest load entries containing the training data (i.e., the size of the data set representing all harvest load entries in the harvest training database). It should be noted that this modeling scheme is more generic and does not fix the sugarcane age and harvest month as was done in connection abs with equations (26) and (27). The value εₙ^{abs} represents the absolute error between predicted yield and actual yield using the training data and is constrained as given by the following inequalities:

εₙ^{abs}≧Yₙ−ŷₙ^{(JD,A)} (33)

εₙ^{abs}≧−(Yₙ−ŷₙ^{(JD,A))} (34)

for all entries n, and where Yₙ is the actual yield for entry n in the training database, ŷₙ^{(JD,A)} is the predicted yield for harvest load entry n using julian and age effects, and

$${\hat{y}}_{n}^{( JD , A )} = {\sum }_{v = 1}^{{N}_{V}} ( {NV}_{n , v} ) ( {\hat{y}}_{v , {HD}_{n} , {A}_{n}}^{( JD , A )} ) \qquad ( 35 )$$

for all n, where Nᵥ is the set of varieties, NV_{n,v} is a binary matrix indicating to which variety v harvest load entry n belongs, such that NV_{n,v} is equal to one when the harvest load of entry n belongs to variety v and otherwise is equal to zero, where

Aₙ=(HDₙ−PDₙ+1) (36)

and

ŷ_{v,HD}_{ₙ}_{,A}_{ₙ}^{(JD,A)}=α_{v,p}^{y}(JD_{HD}_{ₙ})^{p}+α_{v,p-1}^{y}(JD_{HD}_{ₙ})^{p-1}+ . . . +α_{v,1}^{y}(JD_{HD}_{ₙ})¹+cᵥ^{y}Aₙ²+dᵥ^{y}Aₙ+γᵥ^{y} (37)

for all v, and where Aₙ is a parameter indicating the age of the harvest entry n at harvest, HDₙ is a parameter indicating the harvest date of harvest entry n, PDₙ is a parameter indicating the planting date of harvest entry n, ŷ_{v,HD}_{ₙ}_{,A}_{ₙ}^{(JD,A)} is the season and age dependent yield for variety v on harvest date HD at age A in entry n, and JD_{HD}_{ₙ} represents the harvest date HD in entry n in terms of julian date. However, to make the linear programming (LP) relaxation of the constraints given by equations (33) and (34) tight, the following constraint is included into the optimization problem:

εₙ^{abs}≦Yₙ (38)

for all n.

A few additional linear programming tightening constraints obtained by using the domain knowledge about the relationship between age and yield are given as follows:

Yₙ−5≦ŷₙ^{(JD,A)}≦Yₙ+3∀n,∀(Aₙ≦340 or Aₙ≧440) (39)

Yₙ−3≦ŷₙ^{(JD,A)}≦Yₙ+5∀n,∀(Aₙ=341, . . . , 439) (40)

The numbers 3, 5, 340, and 440 are illustrative only and may change depending on geography and the training data selected for creating the models described herein.

It should be noted that the constraints given by equations (33) to (40) are optional constraints. However, these constraints help make the optimization search space more compact. The following additional constraints may be imposed:

α_{v,p}^{y}^{^{low}}≦α_{v,p}^{y}≦α_{v,p}^{y}^{^{high}} (41)

cᵥ^{y}^{^{low}}≦cᵥ^{y}≦cᵥ^{y}^{^{high}} (42)

dᵥ^{y}^{^{low}}≦dᵥ^{y}≦dᵥ^{y}^{^{high}} (43)

γᵥ^{y}^{^{low}}≦γᵥ^{y}≦γᵥ^{y}^{^{high}} (44)

for all v and p. The upper and lower bounds on the above parameters in equations (41) to (44) can be obtained using the results from modeling the julian date and age effects separately. It should be noted that these ranges on parameters are very specific to the training data used for modeling and need to be pre-estimated for other industries' harvest data, as sugarcane is a weather sensitive crop. The linear optimization problem with objective function given by equation (32) and subjected to constraints given by equations (33)-(44) is solved to estimate the optimal values for the parameters.

Once the optimal parameter values are computed, the residual error is calculated according to the following equation:

errₙ=Yₙ−ŷₙ^{(JD,A)} (45)

for all n. Assuming that a residual analysis is tabulated using a set of training data, it will be apparent that there can still be modeling errors in the combined (julian and age) model predictions and that additional variables like weather and/or soil effects can be considered to improve the model and thereby the quality of predictions.

### Modeling Weather Effect on Yield

As discussed earlier, sugarcane yield is influenced by stochastic effects like weather and/or soil conditions. The weather effect is highly complex and poorly characterized in practice. It comprises rainfall, temperature, humidity, wind, and/or sunshine related effects. These individual effects have a dynamic impact on sugarcane yield. For example, sugarcane yield is dependent on the pattern of rainfall on the sugarcane crop throughout its lifetime. Therefore, weather related effects should be modeled within a dynamic framework.

The weather model captures a significant amount of the residual error errₙ (of the combined model of julian date and age effects) using weather information such as rainfall, maximum temperature, and/or the difference between maximum and minimum temperatures (delta temperature). Although only temperature and rainfall data are used herein to model weather effects, the weather model can be more general, comprising other variables such as humidity, sunshine hours, etc.

The yield contribution due to weather related effects on harvest day d in planting zone z may be denoted as ŷ_{d,z}^{W}. As can be seen, the weather contribution factor is a function of the harvest date (d) of the sugarcane crop. Once the harvest date of the crop is known, the related weather information experienced by the sugarcane crop prior to harvest can be computed and put in the model. The yield contribution ŷ_{d,z}^{W} can be modeled in accordance with the following equation:

ŷ_{d,z}^{W}=ŷ_{d,z}^{RF}+ŷ_{d,z}^{MT}+ŷ_{d,z}^{ΔT} (46)

for all d and z. The first term on the right hand side of equation (46) is the rain fall (RF) model that considers past rainfall information (such as rainfall in the last eight months), while the second and last right hand terms indicate dynamic models for maximum and delta temperatures which consider past temperature effects (such as temperature effects in the last six months). Equation (46) also expresses weather variation across different planting zones z.

### Modeling Rainfall Effect on Yield

The rainfall model is dynamic in nature and can comprise, for example, two terms as given in the following equation:

ŷ_{d,z}^{RF}=ŷ_{d,z}^{RF}^{₁₀}+ŷ_{d,z}^{RF}^{₃₀} (47)

for all d and z.

The first term ŷ_{d,z}^{RF}^{₁₀} captures the effect on yield due to the rainfall effect on harvest day d in zone z over the last two months in 6 groups of 10 days each, as given by the following equation:

$${\hat{y}}_{d , z}^{{RF}_{10}} = ( {\sum }_{i = 1}^{6} {rf}_{i}^{y} ) ( {\sum }_{m = 1}^{10} ( {RF}_{d - 10 ( i - 1 ) - m , z} ) ) \qquad ( 48 )$$

for all d and z, where rfᵢ^{y} is a parameter useful in modeling the rainfall effect on yield, and RF_{d,z} is the rainfall on day d in zone z. The groupings used in equation (48) may be different in number and size. There are six rainfall parameters rfᵢ^{y} in equation (47), which will be determined while predicting the effect on yield of rainfall over the last two months (in slots of 10 days each).

The second term in equation (47) captures the effect of rainfall during the last 61 to 240 days in groups of 30 days. Hence, there are six distinct groups. This second term is given by the following equation:

$${\hat{y}}_{d , z}^{{RF}_{30}} = ( {\sum }_{i = 1}^{6} {rf}_{i + 6}^{y} ) ( {\sum }_{m = 1}^{30} ( {RF}_{d - 30 ( i + 1 ) - m , z} ) ) \qquad ( 49 )$$

for all d and z. The groupings used in equation (49) also may be different in number and size.

Hence, equations (48) and (49) over a past period of time (such as 8 months) consider the rainfall effect on yield. There are a total of twelve parameters rfᵢ^{y} in the dynamic rainfall model of equations (48) and (49) to predict the effect of rainfall on yield.

### Modeling Maximum Temperature Effect on Yield

The model to predict the effect of maximum temperature on yield is given by way of example by the following equation:

ŷ_{d,z}^{MT}=ŷ_{d,z}^{MT}^{₁₀}+ŷ_{d,z}^{MT}^{₃₀} (50)

for all d and z, where ŷ_{d,z}^{MT} is the maximum temperature dependent yield on day d in zone z.

The first term ŷ_{d,z}^{MT}^{₁₀} captures the effect on yield due to the maximum temperature effect on harvest day d in zone z over the last two months in ten day slots as given by the following equation:

$${\hat{y}}_{d , z}^{{MT}_{10}} = ( {\sum }_{i = 1}^{6} {mt}_{i}^{y} ) ( {\sum }_{m = 1}^{10} ( {MT}_{d - 10 ( i - 1 ) - m , z} ) ) \qquad ( 51 )$$

for all d and z, where mtᵢ^{y} are parameters to model the effect of maximum temperature on yield, and MT_{d,z} is the maximum temperature in zone z on day d.

The second term ŷ_{d,z}^{MT}^{₃₀} considers the effect on yield of the maximum temperature in the remaining four months (out of the last six months) in thirty days slots as given by the following equation:

$${\hat{y}}_{d , z}^{{MT}_{30}} = ( {\sum }_{i = 1}^{4} {mt}_{i + 6}^{y} ) ( {\sum }_{m = 1}^{30} ( {MT}_{d - 30 ( i + 1 ) - m , z} ) ) \qquad ( 52 )$$

for all d and z.

Hence, there are in total 10 parameters mtᵢ^{y} (six from equation (51) and four from equation (52)) in dynamically modeling the effect of maximum temperature on yield prediction. The groupings used in equation (51) and (52) also may be different in number and size.

### Modeling Delta Temperature Effect on Yield

The dynamic model to capture the effect of delta temperature on yield is very similar to that used for modeling the maximum temperatures effect. Hence, the dynamic model to capture the effect of delta temperature on yield is given by the following equation:

ŷ_{d,z}^{ΔT}=ŷ_{d,z}^{ΔT}^{₁₀}+ŷ_{d,z}^{ΔT}^{₃₀} (53)

for all d and z.

The first term ŷ_{d,z}^{ΔT}^{₁₀} captures the effect on yield due to the difference effect between maximum and minimum temperatures on harvest day d in zone z over the last two months in ten day slots as given by the following equation:

$${\hat{y}}_{d , z}^{Δ {T}_{10}} = ( {\sum }_{i = 1}^{6} δ {t}_{i}^{y} ) ( {\sum }_{m = 1}^{10} Δ {T}_{d - 10 ( i - 1 ) - m , z} ) \qquad ( 54 )$$

for all d and z, and where δtᵢ^{y} are parameters to model the effect of temperature difference on yield, and ΔT_{d,z} is the temperature difference in zone z on day d.

The second term ŷ_{d,z}^{ΔT}^{₃₀} considers the effect on yield of the temperature difference in the remaining four months (out of the last six months) in thirty days slots as given by the following equation:

$${\hat{y}}_{d , z}^{Δ {T}_{30}} = ( {\sum }_{i = 1}^{4} δ {t}_{i + 6}^{y} ) ( {\sum }_{m = 1}^{30} Δ {T}_{d - 30 ( i + 1 ) - m , z} ) \qquad ( 55 )$$

for all d and z.

Hence, there are in total 10 parameters δtᵢ^{y} (six from equation (54) and four from equation (55)) in dynamically modeling the effect of delta temperature on yield prediction. The groupings used in equation (54) and (55) also may be different in number and size.

The combined dynamic model to predict the effect of weather conditions on yield is comprising of a total 32 parameters (12 for rainfall and 10 each for maximum temperature and delta temperature). The weather model represented by equations (46) to (55) is variety independent. In other words, it assumes that all the varieties show similar sensitivity to weather conditions. However, it is straight forward to develop a weather model that considers variety dependency in a similar manner.

### Modeling Combined Effects of Julian Date, Age and Weather on Yield

The weather model of equation (46) is merged with the combined model of the effects of julian date and age, and the optimal values for all parameters (julian date, age, and weather model parameters) of the combined model are obtained using an optimization framework. This combined model is given by the following equation:

$${\hat{y}}_{n}^{( JD , A , W )} = {\hat{y}}_{n}^{( JD , A )} + {\sum }_{z = 1}^{{N}_{Z}} ( {NZ}_{n , z} ) ( {\hat{y}}_{d , z}^{W} ) \qquad ( 56 )$$

for all harvest load entries n in the training database, where ŷₙ^{(JD,A,W)} is the predicted yield of harvest load entry n using the julian date, age, and weather effects, N_{Z} is the set of all zones, and NZ_{n,z} is a binary matrix indicating to which zone z farm a harvest load entry n belongs and is equal to one when zone z corresponds to entry n and it otherwise zero.

The linear optimization problem presented by the objective function given by equation (32) is solved, using the sample training data to estimate the optimal values for all parameters, by subjecting the objective function to the constraints given by equations (33)-(44), by replacing ŷₙ^{(JD,A)} with ŷₙ^{(JD,A,W)}) and by replacing equation (35) with the following equation:

$${\hat{y}}_{n}^{( JD , A , W )} = {\sum }_{v = 1}^{{N}_{V}} ( {NV}_{n , v} ) ( {\hat{y}}_{v , {HD}_{n} , {A}_{n}}^{( JD , A )} ) + {\sum }_{z = 1}^{{N}_{Z}} ( {NZ}_{n , z} ) ( {\hat{y}}_{d , z}^{W} ) \qquad ( 57 )$$

for all n.

Once the optimal parameter values are computed as described above, the residual error is calculated in accordance with the following equation:

errₙ=Yₙ−ŷₙ^{(JD,A,W)} (58)

for all n. Assuming that this residual analysis is tabulated using the set of training data, it will be apparent that there can still be modeling errors in the combined (julian and age and weather) model prediction and that an additional variable for soil effects can be considered to improve the model and thereby the quality of predictions.

### Modeling Soil and Irrigation Effects on Yield

The sugarcane yield of a farm will naturally depend on its soil type, soil quality, irrigation, and farming practices adopted by the farmer. Soil quality represents the quantum of nutrients (like Nitrogen (N), Phosphorous (P), Potassium (K), etc.) available in the soil. Irrigation practices represent the availability of water for the farm field. Farming practices are related to the practices adopted by the farmer at various stages, varying from seed sowing to crop harvest, and include, for example, seed quality, sowing and harvesting methods, fertilizers, pesticides, etc.

Based on these practices, the training data relating to sugarcane yields can be classified into a number of different zones using a sample sugarcane variety of fixed age and fixed harvest month. It can be concluded from such training data that the selected zones represent a gross level classification of soil types. In a zone, various kinds of sugarcane yields can be produced. These variations are related to different farming and irrigation practices.

Training data will show that soil, farming, and irrigation related effects are difficult to quantify and are complex in nature. Therefore, these effects can be modeled in a rule based manner. Based on soil, farming, and irrigation training data, the soil effects can be ranked from rich soil to poor soil. Rich soil indicates an improved sugarcane yield over the average sugarcane yield predicted by the above models, and poor soil indicates sugarcane yield that is under the average sugarcane yield.

The gradations can be made with ranks varying from, for example, one to ten, where one indicates poor sugarcane yield (adverse soil and related effects) and ten represents the best possible sugarcane yield (favorable soil and related effects). Corresponding to each soil rank, a contribution factor is assigned so as to amend the above models in accordance with the following equation:

ŷₙ=ŷₙ^{(JD,A,W)}+ŷₙ^{S} (59)

for all n, where ŷₙ^{S} predicts the sugarcane yield contribution due to soil effects for harvest load entry n, where

$${\hat{y}}_{n}^{S} = {\sum }_{st = 1}^{{N}_{ST}} ( {NS}_{n , st} ) ( {δ}_{v , st}^{S} ) \qquad ( 60 )$$

for all n, where N_{ST} is the set of all soil types, NS_{n,st} is a binary matrix indicating to which soil type st the farm of load entry n belongs and which is equal to one when the soil of the farm corresponding to entry n belongs to soil type st and is otherwise zero, and δ_{v,st}^{S} is the sugarcane yield contribution factor of variety v for soil type st (representing soil and irrigation effects). Because the soil and irrigation effect related contribution factor δ_{v,st}^{S} is dependent on the farm and plant variety, different values of the contribution factor can be obtained for the same farm but planted with different varieties. Optimal values of δ_{v,st}^{S} can be obtained using soil nutrients, irrigation, and farming practice related data of a field (i.e. domain knowledge), or can be obtained using optimization techniques.

The soil model can be combined with the combined julian, age, and weather model. Hence the linear optimization problem with the objective function given by equation (32) and the constraints given by equations (33) and (34) are modified in accordance with the following equations:

$$\begin{matrix}{min}_{( \begin{matrix}{α}_{v , p}^{y} , {α}_{v , p - 1}^{y} , ... , {α}_{v , 1}^{y} , {c}_{v}^{y} , {d}_{v}^{y} , {γ}_{v}^{y} , \\ {rf}_{i : 1 … 12}^{y} , {mt}_{i : 1 … 10}^{y} , δ {t}_{i : 1 … 10}^{y} , {δ}_{v , st}^{S}\end{matrix} )} {\sum }_{n = 1}^{{N}_{E}} {ɛ}_{n}^{abs} & ( 61 ) \\ {ɛ}_{n}^{abs} \geq {Y}_{n} - {\hat{y}}_{n} & ( 62 ) \\ {ɛ}_{n}^{abs} \geq - ( {Y}_{n} - {\hat{y}}_{n} ) & ( 63 )\end{matrix}$$

for all n, and where the unified model is given by the following equation:

$${\hat{y}}_{n} = {\sum }_{v = 1}^{{N}_{V}} ( {NV}_{n , v} ) ( {\hat{y}}_{v , {HD}_{n} , {A}_{n}}^{( JD , A )} ) + {\sum }_{z = 1}^{{N}_{Z}} ( {NZ}_{n , z} ) ( {\hat{y}}_{d , z}^{W} ) + {\sum }_{st = 1}^{{N}_{ST}} ( {NS}_{n , st} ) ( {δ}_{v , st}^{S} ) \qquad ( 64 )$$

for all n.

The set of constraints still include the constraints given by equations (36)-(44) along with the parameter ranges calculated as discussed above. When the unified model (aggregating all effects) is applied on the sample harvest and production data during training, the non-modeled variation (the error between predicted and actual sugarcane yield) has fallen below reasonable limits. It is concluded that the unified model, comprising julian date, age, weather, and soil related effects, accurately predicts sugarcane yield. The non modeled variation after unified model is attributed to complex effects such as plant diseases, sun shine hours, etc. The unified model so developed is used to predict sugarcane yield for the planted sugarcane fields. The unified model explained here is an example for sugarcane yield prediction for those skilled in area. However any reliable mathematical framework and/or heuristic procedures and/or evolutionary techniques and/or experts' or researchers' understanding, etc. can be used to correctly estimate sugarcane yield using the above mentioned parameters.

It is also possible to use an unstructured modeling approach where no particular structure of a model is assumed a priori.

### Harvest Scheduling Using Processing Capacity Metrics

The sugar recovery and sugarcane yield models 20 and 22 as described above are used by an optimizing procedure 24 of FIG. 2 according to an optimization framework in order to optimize the planting and harvesting schedules to maximize net farm returns. This optimization framework is described below.

The planting year for a crop which needs to be harvested is represented by PD^{min}, which is the numerical equivalent of the start date of a planting year, and PD^{max}, which is the numerical equivalent of the end date of the planting year. The harvest year is given by HD^{min}, which is the numerical equivalent of the start date of a harvest year, and by HD^{max}; which is the numerical equivalent of the end date of the harvest year. As indicated, these four parameters are given by a number equivalent to a date. The reference date used to calculate the number equivalent is arbitrarily chosen as 1 Jan. 2000, which is represented as 36526 by its number equivalent.

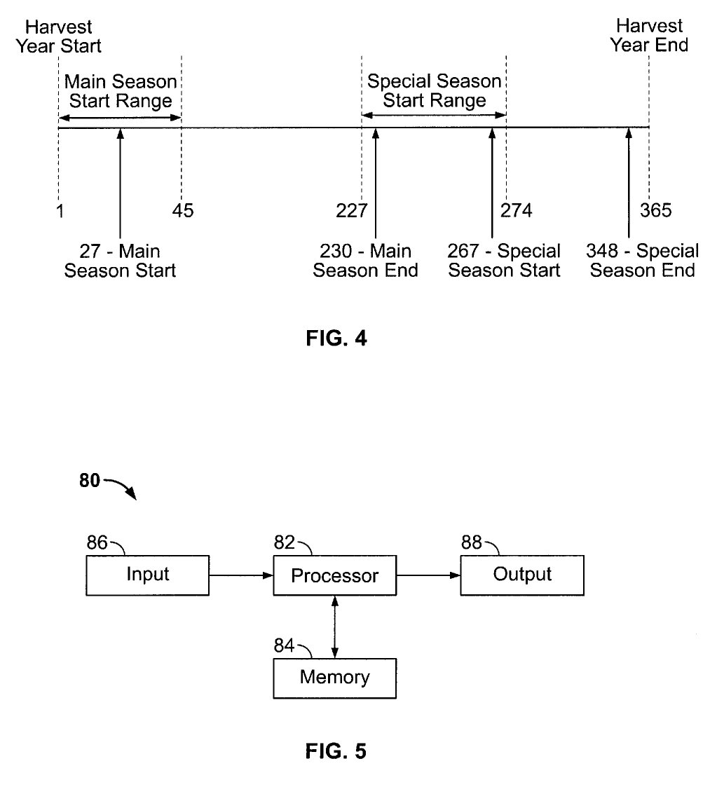

A harvest year is the period during which the factory or mill will process sugarcane loads. For example, as given in FIG. 4, a harvest year can be from Dec. 1, 2007 to Nov. 30, 2008. A planting year is the period spanning between when a crop is planted and when the next crop is planted. For example, a planting year could be from 1 Oct. 2006 to 30 Sep. 2007. On the first day of a harvest season, there is at least one matured sugarcane load ready for harvest.

There are certain dates within the harvest year on which either maintenance is planned or a regional festival (holiday) will be observed. This maintenance and festival schedule is captured using binary vector MF_{d}, in which a value of zero means the day is either a maintenance day or a festival day and a value of one means that the day is neither a maintenance day nor a festival day.

There can be more than one harvest season, such as main and special, within a harvest year. In addition, the main harvest season start date is restricted to a range given by MS^{L}, which is the lower bound on the start date of a main harvest season, and MS^{U}, which is the upper bound on the start date of the main harvest season. The harvest year can have more than one harvest season. The first can be called the main harvest season as it is usually the longest season.

Similarly the special harvest season start date is bounded by SS^{L}, which is the lower bound on the start date of a special harvest season, and SS^{U}, which is the upper bound on the start date of the special harvest season. Any harvest season other than the main harvest season is referred to as the special harvest season. Generally, there are only two harvest seasons during a harvest year, the main harvest season and the special harvest season.

In the formulation described herein, the binary decision variable set ms_{d}^{b} is a binary matrix indicating whether day d belongs to the main harvest season, and the binary decision variable set ss_{d}^{b} is a binary matrix indicating whether day d belongs to the special harvest season. In the main harvest season binary matrix, a one indicates that the day belongs to the main harvest season and a zero indicates that it does not. Similarly, in the special harvest season binary matrix, a one indicates that the day belongs to the special harvest season and a zero indicates that it does not.

If sugarcane planting is not sufficient to run the processing plant during the special harvest season, the processing plant is run only during the main harvest season. Hence, the main harvest season should always start, but starting of the special harvest season is optional.

These considerations give rise to the constraints given by the following equations:

$$\begin{matrix}{\sum }_{d = {MS}^{L}}^{{MS}^{U}} ( {MF}_{d} ) ( {ms}_{d}^{b} ) \geq 1 & ( 65 ) \\ {\sum }_{d = {SS}^{L}}^{{SS}^{U}} ( {MF}_{d} ) ( {ss}_{d}^{b} ) \geq {sse}^{b} & ( 66 )\end{matrix}$$

where the binary variable sse^{b} indicates whether the special harvest season exists. FIG. 4 illustrates an example of main and special harvest season start and end dates and main and special harvest season start ranges. Even though a special harvest season is shown in the FIG. 4, its existence is optional.

In addition, there should be no break (except those due to maintenance and festivals) in the main harvest season as given by the following constraints:

ms_{d}^{b}≦ms_{d+1}^{b}∀(d=MS^{L}, . . . , MS^{U}−1) (67)

ms_{d}^{b}≧ms_{d+1}^{b}∀(d=MS^{U}, . . . , SS^{U}−1) (68)

To maintain continuity, the binary variable ms_{d}^{b} will have a value of one for those maintenance and festival days that are between the start and end of the main harvest season. Thus, for the main harvest season given in FIG. 4, the binary variables ms_{d}^{b} will be equal to one for all days, including maintenance and festival days, between day 27 and day 230, and otherwise will be zero. These day values are by way of example only and other values could instead by chosen. The main harvest season binary variables ms_{d}^{b} exist for the period from MS^{L} (=HD^{min}) to SS^{U}, while the special harvest season binary variables ss_{d}^{b} exist from SS^{L} to HD^{max}.

The harvest season continuity constraints for special harvest season are give by the following expressions:

ss_{d}^{b}≦ss_{d+1}^{b}∀(d=SS^{L}, . . . , SS^{U}−1) (69)

ss_{d}^{b}≧ss_{d+1}^{b}∀(d=SS^{U}, . . . , HD^{max}−1) (70)

Once started, the main and special harvest seasons should run at least for pre-specified minimum numbers of days. This operational constraint is captured by the following equations:

$$\begin{matrix}{\sum }_{d = {SS}^{L}}^{{SS}^{U}} ( {MF}_{d} ) ( {ms}_{d}^{b} ) \geq MH & ( 71 ) \\ {\sum }_{d = {SS}^{L}}^{{HD}^{max}} ( {MF}_{d} ) ( {ss}_{d}^{b} ) \geq ( MH ) ( {sse}^{b} ) & ( 72 )\end{matrix}$$

The parameter MH indicates the compulsory minimum number of operational days for which a harvest season should run. As can be seen from equation (71), the main harvest season can end in the start range for the special harvest season. If the special harvest season does not exist, then the constraint given by equation (72) is relaxed. But, in such a case, the number of operating days in the special harvest season should be equal to zero. This logical constraint is given by the following equation:

$${\sum }_{d = {SS}^{L}}^{{HD}^{max}} ( {MF}_{d} ) ( {ss}_{d}^{b} ) \leq ( {HD}^{max} - {SS}^{L} + 1 ) ( {sse}^{b} ) \qquad ( 73 )$$

However, if the special harvest season exists, then there should be a minimum maintenance gap MG in number of days between the end of main harvest season and the start of special harvest season. This minimum maintenance requirement is represented by the following equation:

ms_{d-MG}^{b}+ss_{d}^{b}≦1∀(d=SS^{L}, . . . , SS^{U}) (74)

The total load crushed by a plant (yield multiplied by area harvested) on any operating day d (belonging to any one of the two harvest seasons) should be greater than the minimum milling or crushing capacity as given by the following constraints (75), (76), and (77), respectively:

$${\sum }_{v = 1}^{{N}_{v}} {\sum }_{a = {AG}_{d}^{min}}^{{AG}_{d}^{max}} ( {\hat{Y}}_{v , d , a} ) ( {ah}_{v , d , a} ) \geq ( {CP}^{min} ) ( {MF}_{d} ) ( {m s}_{d}^{b} ) ∀ ( d = {HD}^{min} , … , {SS}^{L} - 1 )$$

$${\sum }_{v = 1}^{{N}_{v}} {\sum }_{a = {AG}_{d}^{min}}^{{AG}_{d}^{max}} ( {\hat{Y}}_{v , d , a} ) ( {ah}_{v , d , a} ) \geq ( {CP}^{min} ) ( {MF}_{d} ) ( {ms}_{d}^{b} + {ss}_{d}^{b} ) ∀ ( d = {SS}^{L} , … , {SS}^{U} )$$

$${\sum }_{v = 1}^{{N}_{v}} {\sum }_{a = {AG}_{d}^{min}}^{{AG}_{d}^{max}} ( {\hat{Y}}_{v , d , a} ) ( {ah}_{v , d , a} ) \geq ( {CP}^{min} ) ( {MF}_{d} ) ( {ss}_{d}^{b} ) ∀ ( d = {SS}^{U} + 1 , … , {HD}^{max} )$$

The parameter AG_{d}^{max} is the maximum age of a sugarcane load available to harvest on day d, the parameter AG_{d}^{min} is the minimum age of a sugarcane load available to harvest on day d, the parameter Ŷ_{v,d,a} is the predicted yield for plant variety v harvested on day d within age group a, and the parameter CP^{min} is the minimum crushing capacity on any harvesting day. The variable ah_{v,d,a} is the area harvested for variety v on day d of age a.

The default values for parameters AG_{d}^{min} and AG_{d}^{max} may be set at appropriate days such as 300 and 520 days, respectively. However, depending on the start and end of the planting year, these parameters can have values different from their default values. The values for both these parameters will be calculated before executing any instance of the current optimization formulation.

Also the load crushed on any operating day (yield multiplied by area harvested) should be less than the maximum crushing capacity as given by the following constraints (78), (79), and (80), respectively:

$${\sum }_{v = 1}^{{N}_{v}} {\sum }_{a = {AG}_{d}^{min}}^{{AG}_{d}^{max}} ( {\hat{Y}}_{v , d , a} ) ( {ah}_{v , d , a} ) \leq ( {CP}^{max} ) ( {MF}_{d} ) ( {m s}_{d}^{b} ) ∀ ( d = {HD}^{min} , … , {SS}^{L} - 1 )$$

$${\sum }_{v = 1}^{{N}_{v}} {\sum }_{a = {AG}_{d}^{min}}^{{AG}_{d}^{max}} ( {\hat{Y}}_{v , d , a} ) ( {ah}_{v , d , a} ) \leq ( {CP}^{max} ) ( {MF}_{d} ) ( {ms}_{d}^{b} + {ss}_{d}^{b} ) ∀ ( d = {SS}^{L} , … , {SS}^{U} )$$

$${\sum }_{v = 1}^{{N}_{v}} {\sum }_{a = {AG}_{d}^{min}}^{{AG}_{d}^{max}} ( {\hat{Y}}_{v , d , a} ) ( {ah}_{v , d , a} ) \leq ( {CP}^{max} ) ( {MF}_{d} ) ( {ss}_{d}^{b} ) ∀ ( d = {SS}^{U} + 1 , … , {HD}^{max} )$$

The parameter CP^{max} is the maximum crushing capacity on any harvesting day.

In additional, certain constraints can be placed on the total load crushed (with certain percentage deviation) during the entire harvest year such as those given by the following constraints:

$$\begin{matrix}{\sum }_{v = 1}^{{N}_{v}} {\sum }_{d = {HD}^{min}}^{{HD}^{max}} {\sum }_{a = {AG}_{d}^{min}}^{{AG}_{d}^{max}} ( {\hat{Y}}_{v , d , a} ) ( {ah}_{v , d , a} ) \geq ( TL ) ( 1 - \frac{DP}{100} ) & ( 81 ) \\ {\sum }_{v = 1}^{{N}_{v}} {\sum }_{d = {HD}^{min}}^{{HD}^{max}} {\sum }_{a = {AG}_{d}^{min}}^{{AG}_{d}^{max}} ( {\hat{Y}}_{v , d , a} ) ( {ah}_{v , d , a} ) \leq ( TL ) ( 1 + \frac{DP}{100} ) & ( 82 )\end{matrix}$$

where TL is the total annual crushed load, and DP is the percentage deviation allowed on the total annual crushed load.

These constraints are generally used to analyze the profit increase if a capacity increase is suggested. If the entire planted area is to be harvested (which is generally the case in regular practice), then these constraints should be removed from the optimization formulation. The main important constraint is that the area harvested for each variety should be less than or equal to the area planted for that particular plant variety as given by the following constraint (83):

$$\begin{matrix}{HD}^{max} ( : d - pd \leq {AG}_{d}^{max} ) & \\ \sum & ( {ah}_{v , d , d - pd} ) \leq {AP}_{v , d} ∀ \\ d = {HD}^{min} ( : d - pd \geq {AG}_{d}^{min} ) & \end{matrix} ( v ) , \\ ∀ ( pd = {PD}^{min} , … , {PD}^{max} )$$

where the index pd represents the planting day, and the parameter AP_{v,pd} represents the area planted for variety d on planting day pd.

The objective of the harvested scheduling formulation is to maximize net farm returns, which is product of predicted sugar recovery \hat{R}_{v,d,a}, predicted sugarcane yield Ŷ_{v,d,a}, and area harvested ah_{v,d,a} (constrained as given above in equations (65)-(83)) for a given planting. Hence, the objective function is given by the following equation:

$$OBJ = max {\sum }_{v = 1}^{{N}_{v}} {\sum }_{d = {HD}^{min}}^{{HD}^{max}} {\sum }_{a = {AG}_{d}^{min}}^{{AG}_{d}^{max}} ( {\hat{Y}}_{v , d , a} ) ( {\hat{R}}_{v , d , a} ) ( {ah}_{v , d , a} ) \qquad ( 84 )$$

The above objective function implicitly tries to maximize productivity at individual farms by harvesting at optimal times and also to maximize profit at an industry level.

Equation (84) does not include the influence of the predicted price of sugar for day d on the overall returns. Therefore, this sugar price influence can be added to equation (84) in accordance with the following equation:

$$max OBJ = {\sum }_{v = 1}^{{N}_{v}} {\sum }_{d = {HD}^{min}}^{{HD}^{max}} {\sum }_{a = {AG}_{d}^{min}}^{{AG}_{d}^{max}} ( {PCS}_{d} ) ( {\hat{Y}}_{v , d , a} ) ( {\hat{R}}_{v , d , a} ) ( {ah}_{v , d , a} ) \qquad ( 85 )$$

where PCS_{d} is the predicted price of sugar for day d. Thus, equation (85) can be used to select the harvesting date by variety that will maximize returns in terms of price, yield, recovery, and area harvested.

The objective function of equation (85) refers to return from sugar production only. However, along with sugar, byproducts such as molasses and bagasse are also produced from the processing of sugarcane. Molasses can be sold as cattle food, can be fermented to produce ethanol, or can be used as fertilizer. Bagasse can be used in the cogeneration of power or can be sold to the paper industry as a raw material. Thus, the returns from these byproducts also influence the profitability of the sugar industry. Hence, if reliable estimates are available for the process of these byproducts, then the objective can be the maximization of overall profit of the sugar industry.

Accordingly, the objective function of equation (85) can be modified as in the following equations:

$$max OBJ = {\sum }_{v = 1}^{{N}_{v}} {\sum }_{d = {HD}^{min}}^{{HD}^{max}} {\sum }_{a = {AG}_{d}^{min}}^{{AG}_{d}^{max}} ( {PCS}_{d} ) ( {\hat{Y}}_{v , d , a} ) ( {\hat{R}}_{v , d , a} ) ( {ah}_{v , d , a} ) + {\sum }_{v = 1}^{{N}_{v}} {\sum }_{d = {HD}^{min}}^{{HD}^{max}} {\sum }_{a = {AG}_{d}^{min}}^{{AG}_{d}^{max}} ( {PCM}_{d} ) ( {\hat{Y}}_{v , d , a} ) ( • {MC}_{v , d , a} ) ( {ah}_{v , d , a} ) + {\sum }_{v = 1}^{{N}_{v}} {\sum }_{d = {HD}^{min}}^{{HD}^{max}} {\sum }_{a = {AG}_{d}^{min}}^{{AG}_{d}^{max}} ( {PCB}_{d} ) ( {\hat{Y}}_{v , d , a} ) ( • {FC}_{v , d , a} ) ( {ah}_{v , d , a} ) \qquad ( 86 )$$

where PCM_{d} and PCB_{d} are the predicted prices of molasses and bagasse, which are input to the objective function. The parameters ^{□}MC_{v,d,a} and ^{□}FC_{v,d,a} indicate the molasses fraction and fiber content in sugarcane of variety v harvested on day d at age a. The molasses fraction is a complex function of sucrose content, glucose content, and crystallization efficiency of the plant. As is known, the sucrose and glucose content vary with variety, season, age, weather conditions, and soil conditions. The values for the molasses fraction and fiber content can be obtained from historical data or from expert knowledge. The objective function of equation (86) maximizes the overall profitability of the sugar industry.

The harvest scheduling framework is explained herein with respect to one zone and one harvest year. However, it can be simply extended to include multiple zones and multiple harvest years such as two. In addition, we consider two seasons in a given harvest year. However the same formulation can be used for any number of harvest seasons, such as one or three, with minor modifications. The harvest and planting scheduling framework explained above focuses on harvest schedule generation when data about planted loads is known. However, the planting scheduling can be generated (meaning values for AP_{v,pd} are not known but need to be determined) by making simple modifications in the given formulation. The harvest and planting scheduling model can be run multiple times to find optimal capacity or for analysis of different what-if scenarios.

As indicated above, the sugar recovery model produced by the sugar recovery modeling procedure 20 and the sugarcane yield model produced by the sugarcane yield modeling procedure 22 are used by the optimizing procedure 24 of FIG. 2 in order to optimize a planting schedule 26, to optimize a harvesting schedule 28, and to maximize net farm returns 30. As inputs, the optimizing procedure 24 receives planting and harvesting practices data 32, observed and forecasted data 34, and ROI model data 36.

The planting and harvesting practices data 32 includes data indicating the planting year, the harvest year including the main harvest season and the special harvest season, maintenance and festival days, number of varieties, sugarcane ages, etc. that serve to execute the sugar recovery and sugarcane yield models and to optimize the planting schedule 26 and the harvesting schedule 28 and to maximize the net farm returns 30.

The observed and forecasted data 34 includes data that indicates, for example, past and expected rainfall and temperatures, and that serve to execute the sugar recovery and sugarcane yield models.

The ROI model data 36 includes the predicted prices of sugar, molasses, and/or Bagasse, capital cost of capacity expansion, and the like.

In addition, the optimizing procedure 24 receives plant capacity data 38. The plant capacity data 38 includes at least the crushing capacities of the processing plant, the total annual crushed load, and/or the deviation allowed on the total annual crushed load.

The optimization framework implemented by the optimizing procedure 24 is given by equation (86). Maximizing the objective function given by equation (86) based on the planting and harvesting practices data 32, the observed and forecasted data 34, the ROI model data 36, and the plant capacity data 38, as indicated above, will produce the optimized planting schedule 26, the optimized harvesting schedule 28, and the maximized net farm returns 30.

At 40, a return on investment analysis is performed based on the maximized net farm returns 30 using return on investment models 42. The return on investment models 42 model the investments that affect processing plant capacity such as cost of facilities associated with the milling and harvesting of sugarcane, expected prices of sugar, molasses, and/or bagasse, transportation costs, storage costs, and other costs that affect the return on the investment associated with the production of sugar, molasses, and/or bagasse.

This return on investment analysis is used to understand whether or not an increase in capacity is justified. The return on investment analysis, for example, may use standard financial models that incorporate return on investment calculations and are well known to the skilled in art. The optimum planting schedule 26 is produced using some unknown values for AP_{v,pd} and some known values for such parameters as main and special seasons operating days within a framework such as that provided by one of more of equations (65)-(86).

If the return on investment is not satisfactory as determined at 42, the plant data capacity is changed at 38 to reflect a change, such as an increase; in processing plant capacity. Then, the analysis performed at 24, 30, 40, 42, 44, and 38 is performed iteratively until a satisfactory return on investment is determined at 38, at which point an optimum processing capacity 46 is determined and provided as another output. This optimum processing capacity 46 may indicate, for example, that the processing plant that processes the sugarcane should be expanded in order to increase its capacity and thereby maximize return on investment.

The program corresponding to the flow chart of FIG. 2 can be executed in connection with a computer 80 shown in FIG. 7. The computer 80 includes a processor 82, a memory 84, an input device(s) 86, and an output device(s) 88.

The input device(s) 86 may be a mouse, a keyboard, etc. capable of inputting data to the processor 82. The input device(s) 86 may be used to input the training data that includes the yield and recovery data 14, the yield and recovery data 16, and the yield and recovery data 18, and that also includes the planting and harvesting practices data 32, the observed and forecasted data 34, and the ROI model data 36. All of this data may be stored in the memory 84.

The output device(s) 88 may be a monitor, a printer, etc. capable of outputting the planting schedule 26, the harvesting schedule 28, and the net farm returns 30. The output device(s) 88 is also capable of outputting the processing plant capacity 46.

The memory 84 stores the input data, the modeling procedure 10 shown in FIG. 2, and/or the outputs provided by the output device(s) 88.

The plant capacity may be manually supplied at 38 by use of the input device(s) 86 or may be automatically adjusted according to any desired protocol during each iteration of the program.

This iterative program may be described as MILP (mixed integer linear programming). Instead of using iterative MILP (mixed integer linear programming), non-iterative MINLP (mixed integer non-linear programming) may be used. In this latter case, the parameters CPmin and CPmax are treated as variables rather than known values. Apart from this difference, there is no other difference in formulation between iterative MILP (mixed integer linear programming) and non-iterative MINLP (mixed integer non-linear programming) solutions to the optimization formulation.

Certain modifications of the present invention have been discussed above. Other modifications of the present invention will occur to those practicing in the art of the present invention. For example, the present invention has been described above in connection with sugarcane crops. However, the present invention could be used in connection with other crops.

As another example, the order in which seasonal, age, weather, and/or soil effects on yield are modeled may be varied.

As still another example, those who are skilled in the area will recognize that various models have been disclosed above using a polynomial function or a quadratic function. However, the various effects can instead be captured using linear functions or non-linear functions such as exponential, logarithm, etc.

Moreover, modeling techniques other than those described herein can be used to model sugar recovery and sugarcane yield.

Furthermore, the optimizing procedure 24 uses the optimization framework provided, at least in part, by the optimization function of equation (86). However, the optimizing procedure 24 can use the optimization frameworks provided, at least in part, by any of the optimization functions of equations (84), (85), and/or (96), as desired.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A method implemented by a computer for generating a harvesting and/or planting schedule based on a product recovery model and a crop yield model, wherein the product recovery model models recovery of a product from a crop, and wherein the crop yield model models yield of the crop from land, the method comprising:
receiving first input data pertinent to predicting the recovery of the product by use of the product recovery model;
receiving second input data pertinent to predicting the yield of the crop by use of the crop yield model;
receiving third input data related to capacity of processing the crop to produce the product;
receiving fourth input data related to harvesting and/or planting practices of the crop; and,
processing the first, second, third, and fourth input data so as to determine an optimum, harvesting and/or planting-schedule for the crop as a function of the product recovery model, the crop yield model, the crop processing capacity, and the harvesting and/or planting practices.

2. The method of claim 1 wherein the processing comprises processing the first, second, third, and fourth input data in accordance with a function that includes the product recovery model, the crop yield model, and an area of land harvested and/or planted for the crop, and wherein the area of land harvested and/or planted is constrained in accordance with the third and/or fourth data.

3. The method of claim 2 wherein the third data includes maximum and minimum crop processing capacities.

4. The method of claim 2 wherein the function comprises an objective function, wherein the processing comprises maximizing the objection function, and wherein the objective function maximizes net farm return in terms of product produced using terms corresponding to the crop yield model, the product recovery model, and the area of land harvested and/or planted for the crop.

5. The method of claim 1 further comprising receiving fifth input data related to a predicted price of the product, wherein the processing comprises processing the first, second, third, fourth, and fifth input data in accordance with a function so as to determine an optimum harvesting and/or planting schedule and return on investment for the crop, wherein the function includes the product recovery model, the crop yield model, an area of land harvested and/or planted for the crop, and the predicted price of the product, and wherein the area of land harvested and/or planted is constrained in accordance with the third and/or fourth data.

6. The method of claim 5 wherein the function comprises an objective function, wherein the processing comprises maximizing the objection function, and wherein the objective function maximizes net profit and/or net farm return in terms of product value using terms corresponding to the predicted price of the product, the crop yield model, the product recovery model, and the area of land harvested and/or planted for the crop.

7. A method implemented by a computer for generating a harvesting and/or planting schedule and an optimum crop processing capacity based on a product recovery model and a crop yield model, wherein the product recovery model models recovery of a product from a crop, and wherein the crop yield model models yield of the crop from land, the method comprising:
receiving first input data pertinent to predicting the recovery of the product by use of the product recovery model;
receiving second input data pertinent to predicting the yield of the crop by use of the crop yield model;
receiving third input data related to capacity of processing the crop to produce the product;
receiving fourth input data related to harvesting and/or planting practices for the crop;
receiving fifth input data related to return on investment in connection with the crop processing capacity; and,
processing the first, second, third, fourth, and fifth input data so as to determine an optimum harvesting and/or planting schedule and an optimum crop processing capacity for the crop as a function of the product recovery model, the crop yield model, the crop processing capacity, and the harvesting and/or planting practices.

8. The method of claim 7 wherein the processing comprises processing at least the first, second, third, and fourth input data in accordance with a function that includes the product recovery model, the crop yield model, and an area of land harvested and/or planted for the crop, and wherein the area of land harvested and/or planted is constrained in accordance with the third and/or fourth input data.

9. The method of claim 8 wherein the third data includes maximum and minimum crop processing capacities.

10. The method of claim 8 wherein the function comprises an objective function, wherein the processing comprises maximizing the objection function, and wherein the objective function maximizes net farm return in terms of product produced using terms corresponding to the crop yield model, the product recovery model, and the area of land harvested and/or planted for the crop.

11. The method of claim 7 further comprising receiving sixth input data related to a predicted price of the product, wherein the processing comprises processing at least the first, second, third, fourth, and sixth input data in accordance with a function so as to determine an optimum harvesting and/or planting schedule and return on investment for the crop, wherein the function includes the product recovery model, the crop yield model, an area of land harvested and/or planted for the crop, and the predicted price of the product, and wherein the area of land harvested and/or planted is constrained in accordance with the third and/or fourth data.

12. The method of claim 11 wherein the function comprises an objective function, wherein the processing comprises maximizing the objection function, and wherein the objective function maximizes net profit and/or net farm return in terms of product value using terms corresponding to the predicted price of the product, the crop yield model, the product recovery model, and the area of land harvested and/or planted for the crop.

13. The method of claim 7 wherein the processing implements either iterative MILP (mixed integer linear programming) or non-iterative MINLP (mixed integer non-linear programming).

14. A method implemented by a computer for generating a harvesting and/or planting schedule based on a sugar recovery model and a sugarcane yield model, wherein the sugar recovery model models recovery of sugar from a sugarcane crop, and wherein the sugarcane yield model models yield of the sugarcane crop from land, the method comprising:
receiving first input data pertinent to predicting the recovery of sugar by use of the sugar recovery model;
receiving second input data pertinent to predicting the yield of the sugarcane crop by use of the sugarcane yield model;
receiving third input data related to capacity of processing sugarcane to produce sugar;
receiving fourth input data related to harvesting and/or planting practices for the sugarcane crop; and,
processing the first, second, third, and fourth input data so as to determine an optimum harvesting and/or planting schedule for the sugarcane crop as a function of the sugar recovery model, the sugarcane yield model, the sugarcane processing capacity, and the harvesting and/or planting practices.

15. The method of claim 14 wherein the processing comprises processing the first, second, third, and fourth input data in accordance with a function that includes the sugar recovery model, the sugarcane yield model, and an area of land harvested and/or planted for the sugarcane crop, and wherein the area of land harvested and/or planted is constrained in accordance with the third and/or fourth input data.

16. The method of claim 15 wherein the third data includes maximum and minimum sugarcane processing capacities.

17. The method of claim 15 wherein the function comprises an objective function, wherein the processing comprises maximizing the objection function, and wherein the objective function maximizes net farm return in terms of sugar produced using terms corresponding to the sugarcane yield model, the sugar recovery model, and the area of land harvested and/or planted for the sugarcane crop.

18. The method of claim 14 further comprising receiving fifth input data related to a predicted price of sugar, wherein the processing comprises processing the first, second, third, fourth, and fifth input data in accordance with a function so as to determine an optimum harvesting and/or planting schedule and return on investment for sugar, wherein the function includes the sugar recovery model, the sugarcane yield model, an area of land harvested and/or planted for the sugarcane crop, and the predicted price of sugar, and wherein the area of land harvested and/or planted is constrained in accordance with the third and/or fourth input data.

19. The method of claim 18 wherein the function comprises an objective function, wherein the processing comprises maximizing the objection function, and wherein the objective function maximizes net profit and/or net farm return in terms of sugar value using terms corresponding to the predicted price of sugar, the sugarcane yield model, the sugar recovery model, and the area of land harvested and/or planted for the sugarcane crop.

20. The method of claim 14 further comprising receiving fifth input data related to a predicted price of sugar and a predicted price of molasses, wherein molasses is also a product of sugarcane processing, wherein the processing comprises processing the first, second, third, fourth, and fifth input data in accordance with a function so as to determine an optimum harvesting and/or planting schedule and return on investment for sugar and molasses, wherein the function includes the sugar recovery model, the sugarcane yield model, an area of land harvested and/or planted for the sugarcane crop, and the predicted prices of sugar and molasses, and wherein the area of land harvested and/or planted is constrained in accordance with the third and/or fourth input data.

21. The method of claim 20 wherein the function comprises an objective function, wherein the processing comprises maximizing the objection function, and wherein the objective function maximizes net profit and/or net farm return in terms of sugar and molasses value using terms corresponding to the predicted price of sugar, the predicted price of molasses, the molasses fraction in sugarcane, the sugarcane yield model, the sugar recovery model, and the area of land harvested and/or planted for the sugarcane crop.

22. The method of claim 14 further comprising receiving fifth input data related to a predicted price of sugar and a predicted price of bagasse, wherein bagasse is also a product of sugarcane processing, wherein the processing comprises processing the first, second, third, fourth, and fifth input data in accordance with a function so as to determine an optimum harvesting and/or planting schedule and return on investment for sugar and bagasse, wherein the function includes the sugar recovery model, the sugarcane yield model, an area of land harvested and/or planted for the sugarcane crop, and the predicted prices of sugar and bagasse, and wherein the area of land harvested and/or planted is constrained in accordance with the third and/or input data.

23. The method of claim 22 wherein the function comprises an objective function, wherein the processing comprises maximizing the objection function, and wherein the objective function maximizes net profit and/or net farm return in terms of sugar and bagasse value using terms corresponding to the predicted price of sugar, the predicted price of bagasse, the fiber content in sugarcane, the sugarcane yield model, the sugar recovery model, and the area of land harvested and/or planted for the sugarcane crop.

24. The method of claim 14 further comprising receiving fifth input data related to a predicted price of sugar, a predicted price of molasses, and a predicted price of bagasse, wherein molasses and bagasse are also products of sugarcane processing, wherein the processing comprises processing the first, second, third, fourth, and fifth input data in accordance with a function so as to determine an optimum harvesting and/or planting schedule and return on investment for sugar, molasses, and bagasse, wherein the function includes the sugar recovery model, the sugarcane yield model, an area of land harvested and/or planted for the sugarcane crop, and the predicted prices of sugar, molasses, and bagasse, and wherein the area of land harvested and/or planted is constrained in accordance with the third and/or fourth input data.

25. The method of claim 24 wherein the function comprises an objective function, wherein the processing comprises maximizing the objection function, and wherein the objective function maximizes net profit and/or net farm return in terms of sugar, molasses, and bagasse value using terms corresponding to the predicted price of sugar, the predicted price of molasses, predicted price of bagasse on day d, the molasses fraction in sugarcane, the fiber content in sugarcane, the sugarcane yield model, the sugar recovery model, and the area of land harvested and/or planted for the sugarcane crop.
